(19) United States
(12) Patent Application Publication
(10) Pub. No.: US 2022/0374973 A1
(43) Pub. Date: Nov. 24, 2022

(54) Remote Rental Management System and Method

(71) Applicant: Point-of-Rental, Inc., Fort Worth, TX (US)

(72) Inventors: EVAN Matthew FORT, Carrollton, TX (US); MATTHEW BRYAN GAFFIN, Irving, TX (US); WAYNE LAWRENCE HARRIS, Colleyville, TX (US); AHMAD MAJED SEYEDMORTAZA, Grand Prarie, TX (US)

(21) Appl. No.: 17/881,752

(22) Filed: Aug. 5, 2022

Related U.S. Application Data
(63) Continuation of application No. PCT/US21/17694, filed on Feb. 11, 2021.
(60) Provisional application No. 62/975,285, filed on Feb. 12, 2020.

(51) Int. Cl. G06Q 30/06; G06K 7/10; G06K 19/07; G07C 9/00

(52) U.S. Cl. CPC G06Q 30/0645; G06K 7/10366; G06K 19/0723; G07C 9/00571

(57) ABSTRACT

A remote rental system allowing unattended rentals and returns. The rental system may include a locker system in communication with a rental system computer and database for managing the rental process. The locker system may include user verification and item verification sensors. The rental system may also evaluate an item that has been picked up or returned to identify potential damage to the item.

### CROSS-REFERENCE TO RELATED APPLICATION

This application is a continuation of PCT application number PCT/US2021/017694 filed on Feb. 11, 2021, which claims the benefit of priority from U.S. Provisional Application No. 62/975,285 filed on Feb. 12, 2020. Both of which are incorporated herein by reference.

### FIELD OF THE DISCLOSURE

The invention relates generally to the field of remote rental management for movable items.

### BACKGROUND

People rent items on a temporary basis from various rental companies. Examples of rental items include tools, party supplies, equipment and recreational vehicles. Typically, these items are rented directly from a rental company and require the customer to receive the item from a company representative and return the item to a company representative. The company charges the customer for the time that they had the item. Because there is a personal exchange, the rental item may only be available to rent or return during the company's business hours.

While unattended product delivery options exist for online purchasers that want to pick up the product in a store or location, rental options are limited to personal exchanges. This is in part because unlike product purchases that are typically completed once the customer receives the product, rented items are returned and often reused over and over again.

### SUMMARY

The present disclosure teaches a remote rental management system, which facilitates unattended rentals to customers. The system allows for a customer to rent an item when a rental company representative is not available. The remote rental management system coordinates the supply of the item, receipt of the item by the customer, rental time and accounting, and the return of the item.

Some embodiments of the present disclosure provide a locker system with an electronic control kiosk. The locker system kiosk may control one locker or a plurality of associated lockers. The lockers may be part of a single structure, a group of structures attached to each other or independent lockers that are in communication with the kiosk. In some embodiments, the kiosk has a screen to display information and may also operate as an input.

The kiosk may also include a camera, scanner or other reader to recognize a code. For example, the kiosk may include a barcode scanner to read visual codes on printed matter or digitally shown on a display. In some embodiments, the kiosk determines whether to open one or more lockers based on a scanned code. The kiosk may also include one or more cameras to capture images of the person, the item or identifying material for the person or item. These cameras may be built into the locker structure or placed around the structure. The system may use cameras for multiple purposes including security, item inspection, user verification, visual code scanning, etc.

In some embodiments, the lockers may include internal sensors, such as cameras, scales, tag readers, scanners, etc. These sensors may be used to confirm the placement or removal of an item. In some embodiments, they may be used to confirm the correct item is placed in or removed from the locker system. In addition, the sensors may be used to confirm the condition of the item when it is removed and check if the condition is the same when it is returned.

The locker system may be connected to an open or closed communication network via a wireless or wired connection. For example, the locker system may include a wireless WiFi system to connect the kiosk with a WiFi network and the Internet. The locker system is connected to a rental system database and computer through the network connection. The rental system database and computer may be built together or separate components. For example, the rental system database may be located in a cloud network while the rental system computer is located at a rental company's office.

The rental system database and computer may include an inventory of rentable items, along with their location and other pertinent information. In some embodiments, the rental system computer manages the rental process from rental selection and scheduling, coordinating pick-up location and availability, rental charges and time tracking and rental completion. In other embodiments, the rental system computer may not handle inventory and rental selection. In such embodiments, the rental system computer may handle operational logistics for the locker system and a separate rental computer may handle inventory and scheduling.

In some embodiments, the locker system may also include a database and control system that manages locker availability, code reading and processing, locker access. The internal database may include updatable tables storing active access codes and corresponding actions for each code. For example, a delivery code may cause the locker system to identify available locker sizes and allow selection before opening a locker.

Users of the rental system may have mobile devices that communicate with a cellular system or other communication networks, including the Internet. In some embodiments, these devices may use a web browser or an app for the rental system. In other embodiments, they may receive a communication containing a code for the rental process.

Additional aspects, advantages and features are included in the following description of exemplary examples thereof, which description should be taken in conjunction with the accompanying figures, wherein like numerals are used to describe the same feature throughout the figures. All patents, patent applications, articles and other publications referenced herein are hereby incorporated herein in their entirety for all purposes.

### A BRIEF DESCRIPTION OF THE DRAWINGS

Embodiments will now be described, by way of example only, with references to the accompanying drawings in which:

FIG. 1 is an embodiment of a locker rental system;

FIG. 2 is a block diagram view of a locker within the locker system;

FIG. 3 is a block diagram of the kiosk system;

FIG. 4 is a flow chart of an embodiment of an item delivery process;

FIG. 5 is a flow chart of an embodiment of an item rental pickup process; and

FIG. 6 is a flow chart of an embodiment of an item rental return process.

### DETAILED DESCRIPTION

While this invention may be embodied in many different forms, there will herein be described in detail preferred embodiments of the invention with the understanding that the present disclosure is to be considered as an exemplification of the principles of the invention and is not intended to limit the broad aspects of the invention to the embodiments illustrated. It will be understood that the invention may be embodied in other specific forms without departing from the spirit or central characteristics thereof. The present embodiments, therefore, are to be considered in all respects as illustrative and not restrictive, and the invention is not to be limited to the details given herein.

FIG. 1 illustrates an embodiment of a rental system. The rental system includes a locker system 102 having a series of individual lockers 120, 122, 124, 126 and 128 that are different sizes. In addition to lockers designed to hold rentable items, small key lockers may be included to hold keys for rentable vehicles and equipment.

In this embodiment, the locker system 102 includes a kiosk 130 placed in the center of the locker bank and includes a camera 132 adjacent to a touchscreen display 134. A second camera 136 is located next to the locker system 102. The rental system also includes a rental system computer 104 and a database 106, which are in communication with the locker system 102 through network 108. In addition, a first mobile device 110 and second mobile device 112 may interface with the rental system. For illustrative purposes, the first mobile device 110 will refer to a supplier's or rental employee's device and the second mobile device 112 will refer to the customer's or renter's mobile device. The rental system may include multiple mobile devices associated with the rental company employees or agents, renters or system technicians. These mobile devices 110 and 112 may be any type of mobile device, such as a smart phone, tablet, laptop or other mobile computing device.

The touchscreen display 134 operates as a user interface for the locker system 102. The touchscreen display 134 will display information and instructions for a user along with showing input options for a user to select during operation. Some embodiments may include additional or alternative I/O (input/output) components to operate as a user interface. I/O components may include displays, speakers, microphones, tactile controls, such as buttons, knobs and switches, lights, cameras, sensors and other components to provide information to the user or receive information or instruction from the user. In some embodiments, the kiosk 130 may communicate directly with a user's mobile device 110 or 112 over a nearfield communication or other communication standard. In such embodiments, the kiosk 130 may not include I/O components apart from the communication card connected to the kiosk's 130 CPU 150. The user control would be facilitated through the mobile device controls and a corresponding application or other software option.

The camera 132 may be used for a variety of purposes, including security, user verification and item confirmation. While the camera 132 is shown adjacent to the touchscreen 134, it may be integrated into the touchscreen display 134. In addition to or instead of the camera 132, the kiosk 130 may include other sensors or code readers, such as nearfield communication chips, light scanners, biometric scanners, etc., which may be used to control operations of the kiosk 130.

The external camera 136 may be used for surveillance of the locker system 102 for both security purposes and for user and item verification. In some embodiments, the external camera 136 and camera 132 may be used to provide a multiple point of view perspective of the user and the item. The collected multi-view information may then be used for comparison when the user returns the item.

In some embodiments, the user may be verified using the geolocation of their mobile device 112 to ensure that the person who rented the item is present for pickup. For example, during the pickup process the locker system 102 or rental system computer 104 may ping the renter's mobile device 112 to receive a geolocation. If the renter is not present, the kiosk 130 may require additional verification for the person picking up the item. For example, the rental system may send a notice to the original renter and request confirmation that the person is picking it up for them. In other embodiments, the rental app may not provide the rental access code until the customer arrives onsite.

For certain items, user restrictions may be required. For example, renting a recreational vehicle may require a user to be at least 25 years old and have insurance. While the rental system may require the user to input identifying information, such as a photo ID, during the rental process, the cameras 132 and 136 may be used to confirm the person picking up the item is the one who rented the item. For example, the locker system 102 may compare a driver's license image with the captured images by cameras 132 and 136, prior to opening the locker.

Rental systems may include a plurality of locker systems 102, databases 106 and rental system computers 104 arranged in a number of associations. For example, multiple companies may have their own locker systems 102 located at store locations and other offsite locations. Each company may run their own rental application or service that handles rental inventory and scheduling. A logistics company may operate a set of backend rental system computers and databases that receive the rental requests and scheduling orders and then facilitate the item delivery to the company's locker system and customer notifications for access and return of rented items.

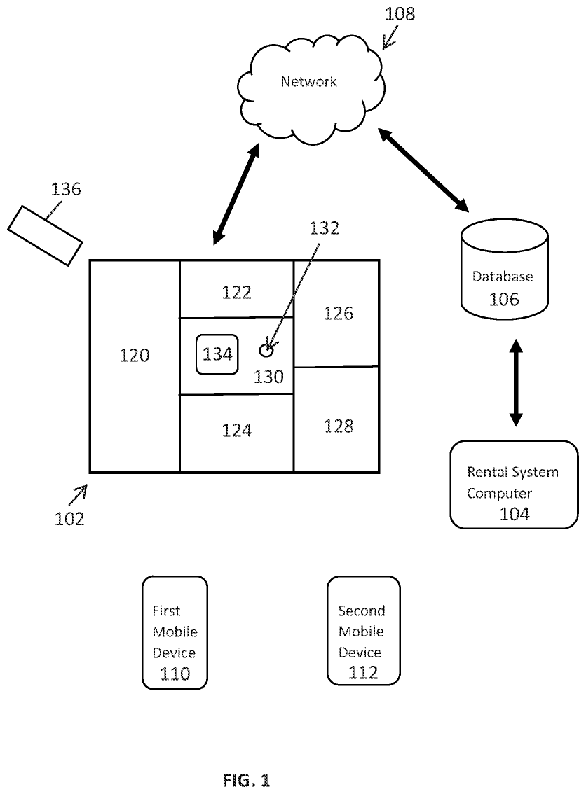

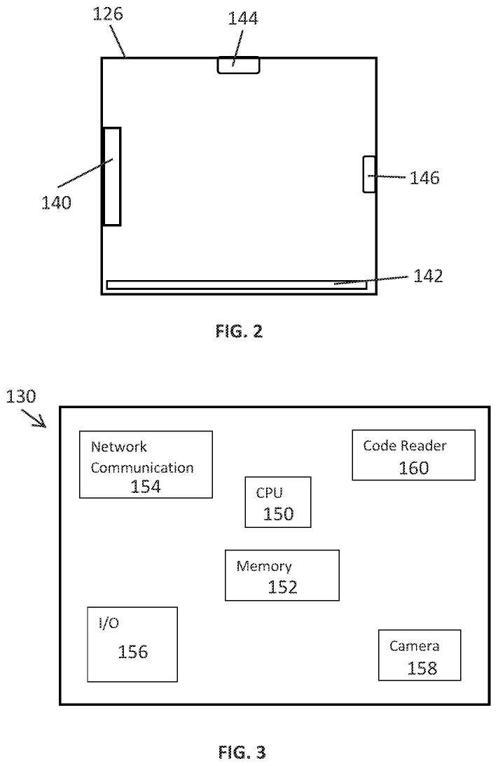

FIG. 2 shows an embodiment of the inside of locker 126. This embodiment is for illustrative purposes and includes a number of features. Lockers may include the same or different features depending on the purpose of the locker. For example, lockers configured to hold expensive items may include more security features than other lockers. Locker 126 includes an electronic latch 140 configured to secure the locker door closed unless the latch 140 is released by the locker control system. In some embodiments, the latch 140 causes the door to pop open when the locker 126 is opened by the locker control system.

The locker 126 includes a scale 142 in this embodiment. The scale 142 may be used to weigh the item placed in the locker 126. The locker system 102 may confirm that the item weight matches an expected item weight to confirm the correct item is placed in the locker 126. The item weight may be based on the anticipated weight for similar items or may be the weight of the item when it was rented to a customer. In some embodiments, the item weight is stored in the rental database 106 and sent to the locker system 102 for item verification.

Some embodiments may include alternative or additional sensors in the base of the locker. For example, the scale 142 may also be a scanner that images the item for comparison to the anticipated item. Such a scanner may also capture and read written indicia or codes attached to the item, such as a serial number, an attached QR code, product name or model number.

This embodiment also includes top sensor 144 and side sensor 146. These sensors 144 and 146 may be cameras, infrared sensors, signal interrogators or other sensors that obtain information about the item. For example, the sensors 144 and 146 may be cameras that are designed to take images of the item to capture evidence of the item's condition. In some embodiments, the locker system 102 may compare images from before the rental to images after the rental to determine if it is the same item or if it has been damaged. As another embodiment, the sensor 144 may include a radio-frequency identification interrogator, which reads an RFID tag on or in the item to ensure that the correct item is placed in the locker 126.

In some embodiments, sensors 144 and 146 may be located in multiple locations around the locker 126. For example, a camera may be placed on all five internal sides of the locker 126 to capture multiple images of the item from all sides. In some embodiments, a camera may be built into the locker door as well to complete the six views. The locker 126 may also contain light features, such as LEDs, that are configured to illuminate the item for pictures.

FIG. 3 provides a block diagram of the kiosk 130. In this embodiment, the kiosk includes a control circuit, such as central processing unit (CPU) 150, memory 152, communication circuit 154, user interface 156, camera 158 and code reader 160. Embodiments may also include alternative or additional components. For example, the kiosk 130 may include a card reader to accept payment or confirm a user's identity. For another example, the locker controls may be separate from the CPU 150 in some embodiments.

The control circuit—CPU 150—may be a microprocessor, a microcontroller, programmable integrated circuit or other computer chip. The CPU 150 is programmed or configured to access a program with operational instructions. In some embodiments, the CPU 150 may include an integrated memory component with operational programs. The CPU 150 is connected to a memory 152, which may store locker access tables and instructions, analysis instructions, and data obtained by sensors in the lockers 120-128, code reader 160, camera 158, associated cameras and surveillance equipment, and through rental applications. The CPU 150 may be directly wired to the memory 152 or indirectly connected through a bus or another component. The CPU 150 is also connected directly or indirectly with the communication circuit 154, the user interface 156, camera 158 and code reader 160.

Memory 152 may be random access memory, read only memory, programmable read only memory, programmable read-write memory, solid state memory or any other type of memory. The memory 152 may store item rental information in some embodiments and facilitate rentals for available products stored in the lockers 120-128.

The communication circuit 154 refers collectively to communication structures, including the communication chip and antenna. In this embodiment, communication circuit 154 is depicted as a cellular communication chip. Examples of communication circuits 154 include BLUETOOTH communication modules, WiFi communication modules, cellular communication modules and other network communication modules. For example, the communication circuit 154 may be a cellular network card that provides communication on the cellular network. In some embodiments, the communication circuit 154 may be a network communication card for landline communications to the Internet.

The user interface 156 may be any type of user interface, such as one or more buttons, switches, touch screen controls, knobs, voice-activated controls. The user interface 156 may include input and output components. Output components may include visual outputs, such as lights and displays, audio outputs, tactile outputs, vibratory outputs or other outputs to communicate information to a user. In some embodiments, the user interface 156 may be facilitated through the communication circuit 154. For example, a user may provide inputs through a phone application. Those inputs may be sent from the phone to the communication circuit 154 of the kiosk 130. In addition, the communication circuit 154 may send outputs to the user's phone. For instance, the communication circuit 154 may send an alert that the rental item is being picked up.

The user interface 156 may be used for operational controls or user inputs for information gathering. Examples of operation controls include code reading controls, item selection controls, locker selection controls, image capture controls or any other control for the operation of the kiosk 130.

The camera 158 may be any type of video or still camera and may include infrared or low-light viewing. The camera 158 may include an internal control circuit to manage image capture operations or the CPU 150 may control the camera's 158 image capture process. In some embodiments, the camera 158 is configured to identify and capture visual codes for processing. Visual codes may include QR codes, 2-D and 1-D barcodes, matrix codes, alphanumeric codes or other visual codes. The camera processor or the CPU 150 will identify the code, process the code and decode the code. The CPU 150 may use the code to determine a next action, such as providing access to a locker 120-128. In some embodiments, the camera 158 may be used to capture item condition information. For example, when a renter picks up an item, the user interface may provide an opportunity for the renter to identify any preexisting damage to the item and take a picture as proof of the preexisting condition. Upon return, the preexisting damage will not be attributed to that renter based on the picture.

In this embodiment, the kiosk 130 also includes a code reader 160. In some embodiments, the code reader 160 may be integrated into the camera 158. In some embodiments, it may be a dedicated camera for reading visual codes, while camera 158 is used for other purposes. In some embodiments, the code reader 160 may be an infrared scanner used to read visual codes. The code reader 160 may be used to read user identification codes (such as employee IDs or driver's license codes), locker access codes or other codes.

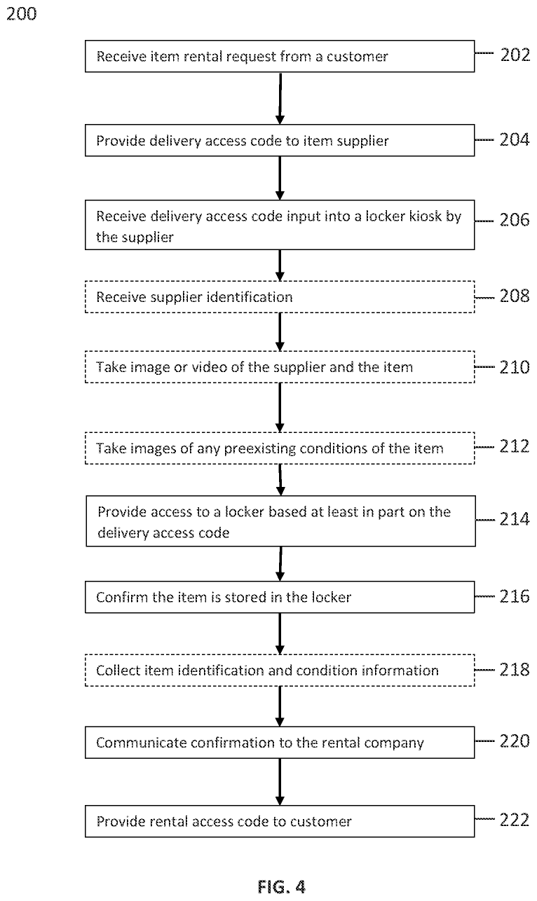

FIG. 4 illustrates a flow chart of an embodiment of delivery process 200, which may be an initial part of the rental process. The delivery process 200 includes some optional steps indicated in dashed lines while common steps are in solid lines. Other embodiments may have additional or alternative optional steps and common steps. The delivery process 200 provides actions from the initial receipt of a rental request, through providing an item to the rental location and providing an access code to the customer. The complete rental process may also include the initial reservation process establishing the rental request and the customer pickup and return process.

Delivery process 200 begins with step 202—receiving a rental request for an item from a customer. Receiving a rental request may include receiving a reservation made through a separate rental app available online or on a user's mobile device 112. During the reservation process, the user may enter necessary information for the rental, including the item, personal information, payment, expected duration, etc. This information is received in the rental system computer 104 and stored in the database 106. The rental system computer 104 may confirm the reservation is complete and an item is available.

In step 204, an access code is provided to the item supplier. For example, the rental system computer 104 may confirm that a selected drill is in inventory and available for rent from a supplier. The rental system computer 104 may then send an access code to the supplier's mobile device 110 along with rental item information. The rental system computer 104 may send the delivery access code using any communication network. For example, the rental system computer 104 may send a text to the supplier's mobile device 112 and an email to the supplier. In some embodiments, the rental system computer 104 may sent an update notice and the supplier may open their rental app to retrieve the code with item rental instructions. The supplier may also scan or register that the item is being removed from its inventory location for rental through the locker system 102.

Concurrently, the rental system computer 104 may send an update including the assigned delivery access code for the item rental to the locker system 102 through the network 108. The update may also include supplier identification and item information.

In step 206, the locker system 102 receives the delivery access code from the supplier. For example, the supplier arrives with the item—e.g., the drill—and pulls up the delivery access code for the locker system 102 on their mobile device 110. The code reader 160 scans or takes an image of the delivery access code from the mobile device 110. The kiosk 130 processes the delivery access code to determine if the access code is valid. In some embodiments, the locker system 102 may provide a keyed access code option to allow a user to enter an alphanumeric code on the touchscreen display 134.

The kiosk 130 may determine if the access code is valid by comparing it to a delivery access database, table or database entry. If it is a valid code, the process may continue to one of the optional steps 208-212 or directly to step 214. If it is not in the delivery access table, the kiosk 130 may determine if the access code is found in the renter access table. If it is in the renter access table, the kiosk 130 will recognize that the user is a renter and follow the rental pickup or return process. If the access code is not in either table, the kiosk 130 will provide an error message or a retry screen.

In step 208, the locker system 102 receives a supplier identification. For example, the locker system 102 may prompt the supplier to scan their driver's license or employee badge for verification. As another example, the locker system 102 may require a supplier identification password. In some embodiments, the locker system 102 may communicate with the supplier's mobile device 110 to retrieve an electronic signal or identification code.

In step 210, the locker system 102 uses cameras 132 and 136 to take images or video of the supplier and the item. For example, the cameras 132 and 136 may take video of the supplier and the item throughout the loading process. The video and the images therefrom may be used to confirm the correct person and item are present. In some embodiments, the locker system 102 may include a facial matching software to confirm if the person in the video is the same as the person who is supposed to deliver the item.

In some embodiments, the cameras 132 and 136 may be motion activated. Accordingly, they may begin recording when movement is detected by either camera 132 or 136. Some embodiments include additional sensors and cameras to capture more information.

In step 212, the locker system 102 is used to capture existing aspects of the item, pre-existing damage or markings. In some embodiments, the images of the item taken by cameras 132 and 136 may be used to identify pre-existing conditions for the item. An operator of the rental system may review images periodically to confirm conditions of an item. In other embodiments, the system may use an artificial intelligence or predictive system to review and identify conditions. The images may subsequently be used for comparison when the item is returned after a rental.

After receiving the access code and any additional identification and images, the locker system 102 provides access to a locker 120-128 based at least in part on the delivery access code in step 214. In some embodiments, the locker system 102 may select a locker 120-128 based on item size information received from the rental system computer or determined from image analysis. For example, the locker system 102 may electronically unlatch locker 126 to allow the supplier to insert the item—e.g., a portable compressor.

In other embodiments, the kiosk 130 shows a locker size selection screen on the touchscreen 134 when a delivery access code is validated. The supplier may then select an appropriately sized locker through the touchscreen 134. For example, the supplier may select a full size locker for skis. Once the locker size is selected, the locker system 102 may unlock and pop open full size locker 120.

In step 216, the locker system 102 confirms that the item is stored in the locker. In some embodiments, the locker system 102 confirms storage once the locker door is shut and locked. In some embodiments, confirmation may include analysis of camera images to show that an item is in the supplier's hands before shutting the locker and that the item is no longer in the locker after shutting the locker. In other embodiments, a scale 142 may be inside the locker to register when an item is placed in the locker.

In step 218, the locker system 102 confirms item identification and condition information. In some embodiments, the locker system 102 confirms the item based on weight, using scale 142 to measure the inserted item's weight and comparing the weight to an expected weight for the item stored in a local memory 152 or received from database 106.

In some embodiments, the locker system 102 includes RFID interrogators configured to read RFID tags on or in rental items. An RFID antenna may be located in the locker 120-128 for short-range scanning designed to identify the item that is placed in the particular locker. For example, the locker 122 may include an RFID antenna in the locker door. When the item passes by the open locker door and into the locker 122, the RFID antenna reads the item's RFID tag having an item identifier. The locker system 102 stores the item identifier in memory associated with the locker 122.

In another embodiment, the locker 120 includes a series of cameras to capture images from multiple angles within the locker 120 after the locker is closed with the item inside. The locker 120 may include a series of light features, such as LEDs, to illuminate the inside of locker 120 for the cameras. The collected item images are stored in memory 152 associated with locker 120. These images may be used to both confirm the item identification and to collect condition information of the item, such as housing damage, broken features or other preexisting condition information.

In some embodiments, the locker 124 may contain electronic scanners to capture condition information related to mechanical components, such as internal electronics and magnetic components. Some embodiments include combinations of these and other sensors to confirm the item identification and condition.

In step 220, the locker system 102 communicates confirmation and item information to the rental system computer 104. The locker system 102 communicates through the kiosk's 130 network communication circuit 154 to the network 108. In some embodiments, communication with the rental system computer 104 may occur multiple times through the process. For example, initial images of the supplier and item may be sent to the rental system computer 104 for validation analysis when they are captured. In addition, notifications that the locker system 102 is in use may be sent, which allows a remote person to view the exchange through cameras 132 and 136.

The communication to the rental system computer 104 may include item confirmation and condition information, item identification information, locker location and identification, supplier information, comments added by the supplier and other information. For example, the locker system 102 may send a load confirmation with the original delivery access code, a locker number, images showing the item and its condition, and its RFID tag information. This information may be stored in database 106.

In step 222, the rental system computer 104 provides a notice with a rental access code to the customer who reserved the item for rental. In addition to the rental access code, the customer notice may include reservation information, images of the item, directions to the locker system 102 and other information. The customer notice may be scheduled for sending once the locker system 102 confirms the item is loaded into a locker and within a threshold amount of time prior to the scheduled customer pickup—e.g., one hour before pickup.

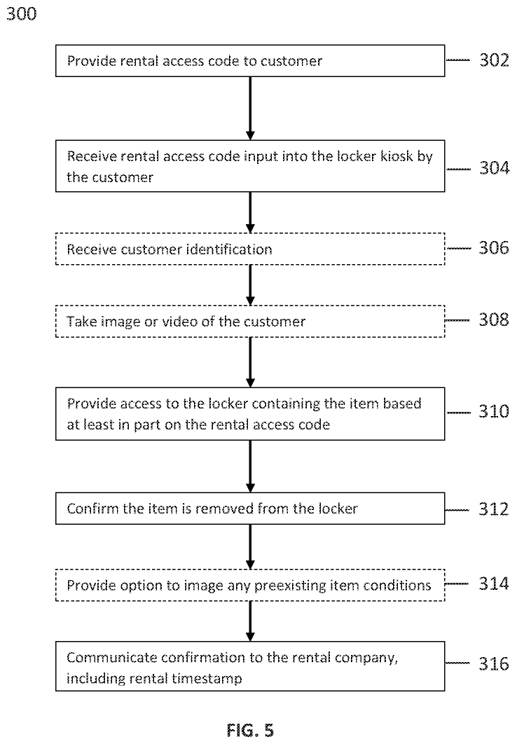

FIG. 5 illustrates a rental pickup process 300 for a customer. In some embodiments, the rental pickup process 300 may follow the delivery process 200. In other embodiments, the rental pickup process 300 may be used for a locker system 102 that is preloaded with rental items that may be reserved and rented out at any time. The lockers 120-128 remain loaded unless the item is being actively rented or is removed for repair. A user may also decide to rent an available item from the locker system's 102 kiosk 130 using a credit card and driver's license. The kiosk 130 may read the driver's license to prepopulate customer information to also make the rental process more efficient.

In step 302, the rental system computer 104 provides a rental access code to a customer. The rental access code may be provided in the same ways as the delivery access code. For example, the rental system computer 104 may confirm that a selected drill is available for rent and stored in locker system 102. The rental system computer 104 may then send an access code to the customer's mobile device 112 along with the rental item information. The rental system computer 104 may send the rental access code using any communication network. For example, the rental system computer 104 may send a text to the customer's mobile device 112.

Concurrently, the rental system computer 104 may send an update to the locker system 102 through the network 108 including the assigned rental access code for the item rental. The update may also include customer identification, item information and a locker or lockers with acceptable items for rental.

In step 304, the locker system 102 receives the rental access code from the customer. For example, the customer arrives and pulls up the rental access code on their mobile device 112. The code reader 160 scans or takes an image of the rental access code from the mobile device 112. The kiosk 130 processes the rental access code to determine if the access code is valid. In some embodiments, the locker system 102 may provide a keyed access code option to allow a user to enter an alphanumeric code on the touchscreen display 134.

The kiosk 130 may determine if the access code is valid by comparing it to a rental access database, table or database entry. If it is a valid code, the process may continue to one of the optional steps 306 or 308, or directly to step 310. If the access code is not in a table, the kiosk 130 will provide an error message or a retry screen.

In step 306, the locker system 102 receives a customer identification. For example, the locker system 102 may prompt the customer to scan their driver's license for verification. As another example, the locker system 102 may require a credit card associated with the rental reservation. In some embodiments, the locker system 102 may communicate with the customer's mobile device 112 to retrieve an electronic signal or identification code.

In step 308, the locker system 102 uses cameras 132 and 136 to take images or video of the customer. For example, the cameras 132 and 136 may take video of the customer throughout the pickup process. The video and the images therefrom may be used to confirm the correct person is picking up the item. In some embodiments, the locker system 102 may include a facial matching software to confirm if the person in the video is the same as the person who is supposed to receive the item.

In some embodiments, the cameras 132 and 136 may be motion activated. Accordingly, they may begin recording when movement is detected by either camera 132 and 136. Some embodiments include additional sensors and cameras to capture more information.

In some embodiments, the locker system 102 may provide images of the stored item for the customer to review prior to opening the locker. If the locker system 102 holds multiple corresponding items, the locker system 102 may display images for each of the available items and allow the customer to select the preferred item. In some embodiments, the rental app on the user's mobile device 112 may include an augmented reality option to allow a person to view the available items in the lockers 120-128.

After receiving the access code and any additional identification and images, the locker system 102 provides access to the item locker 120-128 based at least in part on the rental access code in step 310. In some embodiments, the locker system 102 may select the locker 120-128 based on customer selection received through the kiosk 130. In other embodiments, the rental access code may be correlated to a specific locker by the rental system computer 104. For example, the locker system 102 may electronically unlatch locker 126 to allow the customer to remove the item—e.g., a portable compressor.

In step 312, the locker system 102 confirms that the item has been removed from the locker. In some embodiments, the locker system 102 confirms removal once the locker door is shut and locked. In some embodiments, confirmation may include analysis of camera images to show an item being removed from the locker. In other embodiments, a scale 142 may be inside the locker to register when an item is removed from the locker. Upon the removal of the item and closing of the locker, the locker system 102 stores a rental timestamp for the rental process in memory.

In step 314, the kiosk 130 provides an option for the customer to image any preexisting condition of the item. The customer may select the option to take an image or complete the rental process. If the customer selects the option, they can hold the item in front of camera 132 to show any preexisting damage prior to taking the item. In some embodiments, the kiosk 130 touchscreen 134 may show images of the item taken when loaded in the locker for the customer to select any locations of preexisting damage. In some embodiments, the locker system 102 may include a time limit for the customer to indicate a preexisting condition.

In step 316, the locker system 102 communicates rental confirmation information to the rental system computer 104. The locker system 102 communicates through the kiosk's 130 network communication circuit 154 to the network 108. In some embodiments, communication with the rental system computer 104 may occur multiple times through the process. For example, initial images of the customer may be sent to the rental system computer 104 for validation analysis when the images are captured. In addition, notifications that the locker system 102 is in use may be sent, which allows a remote person to view the exchange through cameras 132 and 136.

The communication to the rental system computer 104 may include customer indicated condition information, item identification information, locker availability, customer information, comments added by the customer and other information. For example, the locker system 102 may send a rental confirmation with the rental access code, a locker number, images showing the item and its condition, and its RFID tag information. This information may be updated and stored in database 106.

The rental system computer 104 provides a notice with the rental timestamp to the rental company and the rental system computer 104. In addition to the rental timestamp, the notice may include reservation scheduling information, images of the item and customer, and other information.

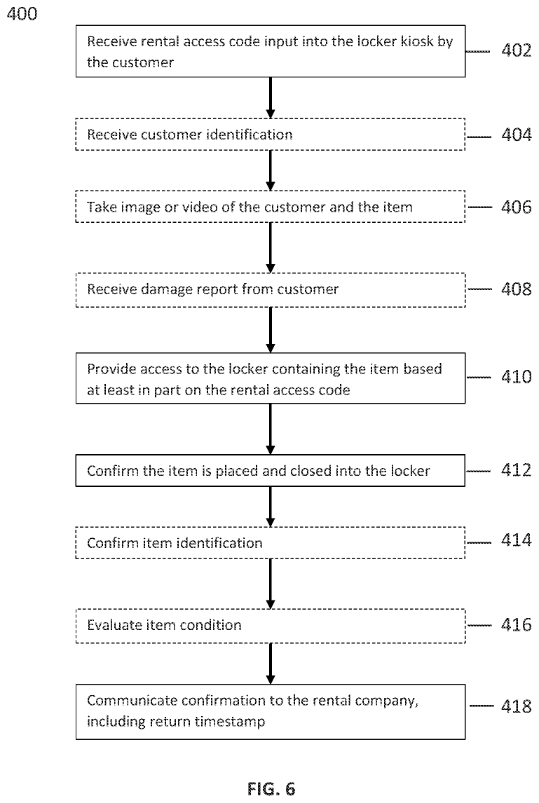

FIG. 6 illustrates a rental return process 400 for a customer. In some embodiments, the rental return process 400 may follow the pickup process 300. In other embodiments, the rental return process 400 may be used for returning items to a locker system 102 that were originally picked up in person at a store. This may allow for after-hours rental returns.

In step 402, the locker system 102 receives the rental access code from the customer for returning the item. For example, the customer arrives and pulls up the rental access code on their mobile device 112. The code reader 160 scans or takes an image of the rental access code from the mobile device 112. The kiosk 130 processes the rental access code to determine if the access code is valid. In some embodiments, the locker system 102 may provide a keyed access code option to allow a user to enter an alphanumeric code on the touchscreen display 134. During processing, the locker system 102 may determine that an access code has already been scanned, indicating a return is in process.

In some embodiments, the customer may receive a return access code that is different from the rental access code. The customer may provide the return access code to the locker system 102 in the same way the rental access code is provided.

The kiosk 130 may determine if the access code is valid by comparing it to a rental access database, table or database entry. If it is a valid code, the process may continue to one of the optional steps 406 or 408, or directly to step 410. If the access code is not in a table, the kiosk 130 will provide an error message or a retry screen.

In step 404, the locker system 102 receives a customer identification. For example, the locker system 102 may prompt the customer to scan their driver's license for verification. As another example, the locker system 102 may require a credit card associated with the rental reservation. In some embodiments, the locker system 102 may communicate with the customer's mobile device 112 to retrieve an electronic signal or identification code.

In step 406, the locker system 102 uses cameras 132 and 136 to take images or video of the customer and the item. For example, the cameras 132 and 136 may take video of the customer and item throughout the return process. The video and the images therefrom may be used to confirm the correct item is being returned. Images of the item may be processed by the locker system 102 to confirm whether the item matches the rented item. In some embodiments, the locker system 102 may also confirm the same person is returning the item and may include a facial matching software to confirm if the person in the video is the same as the person who rented the item.

The cameras 132 and 136 may be motion activated and may begin recording when movement is detected by either camera 132 or 136. Some embodiments include additional sensors and cameras to capture more information. For example, the locker system 102 may include an RFID interrogator to read the item's RFID tag and confirm that it is the same item before it returns to the locker. The locker system 102 may use long range RFID to ensure the correct item is present at the return process and short range RFID to ensure the correct item is placed into the locker. If the same item is not present, the locker system 102 may send an immediate notification to the rental company via the communication network 108.

In step 408, the customer may be provided an opportunity to report damage to the item. For example, the kiosk 130 will prompt a user to indicate if there was damage to the item during the rental. If not, the process will continue to provide locker access in step 410. If the customer indicates the item was damaged, the locker system 102 may immediately notify the rental company. In some embodiments, the locker system 102 may concurrently provide an opportunity for the customer to identify the damage. For example, the locker system 102 may provide images of the item for the customer to mark the damage locations on the item. In some embodiments, the rental system computer 104 may also send a damage survey to the customer after the item is returned.

After receiving the access code and any additional identification and images, the locker system 102 provides access to the item locker 120-128 based at least in part on the rental access code in step 410. In some embodiments, the locker system 102 may select the locker 120-128 based on the item characteristic through the kiosk 130. For example, the locker system 102 may select locker 124 or 128 for returning a pipe cleaning tool that may be dirty because those lockers are appropriately sized and easier to clean. In other embodiments, the access code may be correlated to a specific locker by the rental system computer 104. For example, the locker system 102 may electronically unlatch locker 126 to allow the customer to return the item.

In step 412, the locker system 102 confirms that the item is placed into the locker 124 and the locker door is properly shut. The locker system 102 will store a return timestamp in memory 152 indicating the end of the rental for the customer. This return timestamp will be used along with the rental timestamp by the rental system computer 104 to determine the rental time for the customer.

In some embodiments, the locker system 102 will capture images of the item as it is being placed in the locker 124. The internal cameras may begin taking video or images as soon as the locker door opens.

In some embodiments, sensors inside the locker 124 confirm that an appropriate item is returned. For example, a scale 142 may determine the returned item is within an acceptable weight range. As another example, the internal cameras may capture images of the item to confirm that it matches the type of rented item.

In step 414, the rental system confirms the item's identification to ensure that the returned item is the same as the rented item. In some embodiments, the item is scanned by an RFID reader as it is placed in the locker 124 to ensure that it has the correct RFID tag. If there is no tag or it does not match, the locker system 102 may immediately notify the rental company. As another example, the locker's 124 internal sensors may read item identification information once it is placed in the locker 124.

In some embodiments, locker cameras surrounding the item may take pictures after the item is placed in the locker 124. Closing the locker may trigger the camera system to take images. LEDs may be included in the locker to ensure the item is visible. The camera images may be analyzed by the locker system 102 or the rental system computer 104 to determine if they match images of the item taken prior to the rental.

In addition to confirming the item identification, the item condition may be evaluated in step 416. For example, in addition to identifying the item through image matching, the rental system may determine if the images indicate the condition of the item is different. In some embodiments, the locker system 102 may send the images to the rental system computer 104. The rental system computer 104 may conduct a high resolution comparison with the original images stored in database 106 to identify any locations on the item indicating different coloring or shape. If distinctions are identified, the rental system computer 104 may determine if the distinctions are likely to indicate damage to the item. For example, minor discolorations adjacent to texture in the item may be attributable to shadowing differences in the images. In contrast, longer lines that follow a new pattern counter to the original texture may indicate a crack or significant scratch.

If damage is indicated, the rental system computer 104 will determine if the identified damage surpasses a threshold damage level for that item. For example, small discolorations on a tool's housing may indicate superficial scratches that are anticipated by use of the tool. The rental system computer 104 may determine that these are within an acceptable threshold. For another example, the same superficial scratches on high-end radio equipment may not be acceptable due to the potential internal damage to electronics. In some embodiments, other scanning or sensing techniques may be used to evaluate potential internal damage or non-visual damage to the device. For example, the system may include an X-ray imager to view items inside cases.

If damage is indicated, the locker system 102 or rental system computer 104 may notify the rental company immediately. The locker system 102 may also capture additional images of the customer or request additional customer identification based on the condition evaluation. In some embodiments, the kiosk 130 may provide an additional reminder that the customer will be charged for any damage to the item if condition evaluation indicates possible damage.

In addition, the condition evaluation may review the returned items to determine if any parts are missing. For example, the evaluation may determine that the battery charger for a cordless drill was not returned with the drill.

In other embodiments, the condition evaluation may be conducted within the kiosk 130. The control circuit 150 may analyze the images from the cameras and the memory 152 to determine any potential damage that exceeds a threshold.

Those having ordinary skill in the art will recognize that combinations of these systems and other systems may be implemented within the locker to confirm the item identification and condition. Including redundant or overlapping features increases the level of accuracy in the item identification and condition evaluation. It also reduces the likelihood of incorrectly identifying a return item. It also improves the ability to address damaged items promptly with that customer and for ongoing rental schedules for other customers.

In some embodiments, a locker system 102 may include different lockers with different levels of identification and condition evaluation capability. More expensive or fragile items may be placed in the lockers with heightened features while less expensive items may be managed through lockers with less sophisticated identification features.

In step 418, the locker system 102 communicates return confirmation information to the rental system computer 104. The locker system 102 communicates through the kiosk's 130 network communication circuit 154 to the network 108. In some embodiments, communication with the rental system computer 104 may occur multiple times through the process. For example, return images of the customer and item may be sent to the rental system computer 104 for validation analysis when they are captured. As another example, images of the item may be sent as soon as they are taken in the locker to expedite item identification and condition evaluation if those processes are conducted by the rental system computer 104. In addition, notifications that the locker system 102 is in use may be sent, which allows a remote person to view the exchange through cameras 132 and 136.

The communication to the rental system computer 104 may include a return timestamp, customer indicated damage information, item identification information, locker number, customer information, comments added by the customer and other information. For example, the locker system 102 may send a return confirmation with the rental access code, a timestamp, a locker number, images showing the item and its condition, and its RFID tag information. This information may be updated and stored in database 106.

The rental system computer 104 provides a notice with the return timestamp to the rental company and the rental system computer 104. In addition to the return timestamp, the notice may include reservation scheduling information, images of the item and customer, and other information.

The rental system computer 104 will determine the rental time based on the return timestamp and the rental timestamp. Once the rental time is calculated, the locker system 102 may provide a receipt to the customer for the returned item. In some embodiments, the receipt will be provided prior to completing the item identification process or the condition evaluation.

In other embodiments, the receipt will only be provided after completing the item identification and condition evaluation. In such embodiments, the kiosk's 130 touchscreen 134 may display a current action checklist or timer to let the customer know the system's progress. If the condition evaluation indicates damage, the touchscreen 134 may show side-by-side images of the item before rental and after rental for the customer to see any potential issue identified by the system.

In some embodiments, the touchscreen 134 will facilitate further communication with the rental company. For example, if there is a condition issue, the customer may be able to contact a rental company representative to discuss the issue further.

While the examples have been related to rental of an item, the rental system may be used for the rental of a plurality of items at the same time. In such embodiments, the rental system may require separate lockers for each rental item wherein the process remains the same for each item. To facilitate proper item placement, the kiosk 130 may identify the locker and the appropriate item in a serial pattern. In other embodiments, the kiosk 130 may open the correct number of lockers 120-128 and allow the user to place the items or remove the items. For the return of items, the locker system 102 may then use sensors (e.g., RFID readers, cameras, scales, etc.) to determine which item was placed in each locker.

In some embodiments, the locker system 102 may allow rental or return of multiple items from a single locker. The locker sensors 144 and 146 may capture identifying information and images of all items collectively. The locker system 102 or rental system computer 104 may analyze images to build an item by item identification. In some embodiments, the kiosk 130 may instruct a customer to hold the item in front of camera 132 for imaging before it is returned to a locker. One having ordinary skill in the art will understand that the locker system 102 may allow certain items to be loaded in the same locker, while other items may require their own locker based on the rental company requirements, value of the item, size of the item or other reasons.

The locker system 102 may be used in combination with in-person rentals for after-hour pick-ups or returns. For example, the customer may enter a store during customary, business hours and rent a saw at the counter, during which the company representative may take images of the item or place it in a locker located on the counter for imaging while handling the transaction. The customer may receive a return access code from the rental company in order to return the saw to a locker system 102.

In some embodiments, items may include return access codes printed onto the housing or using an electronic tag. In the event that a customer returns after-hours, the locker system 102 may use the embedded code to facilitate a return. The rental system computer 104 can match the item identification with the customer through the database 106, which stores rental transaction information.

In addition to locker systems 102, the rental system may be configured to work with locks or caged systems for certain equipment. For example, recreational vehicles on trailers may be kept in lockable cages. The cages may operate like the lockers with a kiosk configured to provide access to the appropriate cage. In some embodiments, the cages may not have an internal locking mechanism and may be held shut by an external lock that includes a nearfield communication (such as a Bluetooth communication module) in communication with a kiosk. The lock may be opened to provide access to the cage by the kiosk. In other embodiments, the kiosk operations may be managed through a mobile device's rental app. The lock may be set to open based on communication from the customer's mobile device 112 using a code provided through the app.

In some embodiments, the locker system 102 may facilitate unattended exchanges. For example, if a user rented a battery-operated drill that did not come with a charger, they may return to the locker system 102 once the battery is drained to exchange the drill with a fully-charged drill. The rental system may receive the return timestamp and a second rental timestamp as part of the exchange, but consolidate the rental time for the customer. In addition, the rental company would be notified of the locker number and location holding the uncharged drill. The locker would be marked as unavailable until the rental company updates the system. This unavailable indication would also be used for the return of damaged and dirty items to ensure a subsequent customer does not receive an uncharged, dirty or damaged item.

In some embodiments, the locker system 102 may include specialty lockers designed for specific purposes. For example, a locker system 102 that rents cordless items may include a series of charging lockers that hold batteries in a charger. When renting a cordless item, the kiosk 130 would open the item locker and the locker for a charged battery. On return, the kiosk 130 would open the item return locker and an open charging locker.

The invention being thus described and further described in the claims, it will be obvious that the same may be varied in many ways. Such variations are not to be regarded as a departure from the spirit and scope of the invention, and all such modifications as would be obvious to one skilled in the art are intended to be included within the scope of the apparatuses and methods described.

1. A locker system comprising:
a locker having an interior cavity defined by side walls, a top, a bottom and a back and a locker door in a front that provides access to the interior cavity when in an open position, wherein the locker door is secured in a closed position with an electronic latch attached to one of the side walls;
a kiosk comprising:
a user interface that receives input from a user and provides information to the user,
a network communication circuit configured to communicate with a rental system computer over a network,
a memory that stores a database containing locker access permission for the locker system, wherein the locker access permission is based on an access code received from the rental system computer,
a camera configured to capture images, and
a control circuit that is connected to the user interface, the memory, the network communication circuit and the camera, and controls the electronic latch,
wherein during a rental pickup of an item from the locker, the camera captures a rental access code from a customer who received it from the rental system computer, wherein the control circuit compares the rental access code with the access code in the database to determine the locker access permission, the control circuit releases the electronic latch for the locker corresponding to the locker access permission, the locker system confirms the item is removed from the locker and stores a rental timestamp in the memory, and sends pickup confirmation to the rental system computer with the rental timestamp; and
wherein during a rental return of the item from the locker, the camera captures the rental access code from the customer, the control circuit compares the rental access code with the access code in the database to determine the locker access permission, the control circuit releases the electronic latch for the locker corresponding to the locker access permission, the locker system confirms the item is placed into the locker and stores a return timestamp in the memory, and sends return confirmation to the rental system computer with the return timestamp.

2. The locker system of claim 1, wherein during the return process, the camera captures an item image and the control circuit compares the item image with a pre-rental item image to confirm the item returned is the same as the item rented.

3. The locker system of claim 1, wherein the locker includes at least one internal camera within the interior cavity to capture images of the item within the locker.

4. The locker system of claim 3, wherein prior to the pickup process, the at least one internal camera captures a pre-rental item image; and during the return process, the at least one internal camera captures a return item image and the control circuit compares the return item image with the pre-rental item image to confirm the item returned is the same as the item rented.

5. The locker system of claim 4, wherein the control circuit further evaluates a condition of the item returned as part of comparing the return item image with the pre-rental item image.

6. The locker system of claim 1, wherein the locker system includes an RFID reader and the item has an RFID tag, and the database contains an item identification including the RFID tag, wherein the RFID reader reads the RFID tag and the control circuit determines if the RFID tag matches the item identification.

7. The locker system of claim 6, wherein the RFID reader includes an antenna located in the locker door.

8. The locker system of claim 1, wherein, during the rental pickup of the item from the locker, the control circuit further requires a customer verification for the locker access permission.

9. The locker system of claim 8, wherein the customer verification is a determination that the customer is present when the control circuit receives a geolocation from a mobile device associated with the customer.

10. A method for managing rental items comprising:
receiving a rental reservation from a customer for an item;
assigning a rental access code for the customer to rent the item from a rental location having a rental kiosk, wherein the rental kiosk includes a user interface, a network communication circuit, a memory that stores a database containing access permission for the rental location, a sensor and a control circuit that is connected to the user interface, the memory, the network communication circuit and the sensor, and the control circuit controls an electronic lock at the rental location;
providing the rental access code to the rental kiosk via the network communication circuit to permit access to the rental location;
providing the rental access code to the customer via wireless communication to the customer's mobile device;
receiving rental pickup confirmation from the rental kiosk via the network communication circuit, wherein the rental pickup confirmation includes a rental timestamp and indicates that the rental kiosk received the rental access code from the customer, provided access to the rental location and the item was removed from the rental location;
storing rental information including customer information, item identification and the rental timestamp;
receiving rental return confirmation from the rental kiosk via the network communication circuit, wherein the rental return confirmation includes a return timestamp and indicates that the kiosk received the rental access code from the customer, provided access to the rental location and the item was placed in the rental location; and
calculating a rental time covering time between the rental timestamp and the return timestamp.

11. The method of claim 10, wherein the rental location is a locker.

12. The method of claim 10, further comprising the steps of:
assigning a delivery access code to a rental company to supply the item;
providing the delivery access code to the rental kiosk via the network communication circuit to permit access to the rental location;
providing the delivery access code to the rental company via wireless communication to the rental company's mobile device;
receiving item delivery confirmation from the rental kiosk via the network communication circuit, wherein the item delivery confirmation includes the rental location and indicates that the rental kiosk received the delivery access code from the rental company, provided access to the rental location and the item was placed in the rental location.

13. A rental system comprising:
a rental location having an access controlled space, which is secured in a closed position with an electronic lock;
a kiosk comprising:
a user interface that receives input from a user and provides information to the user,
a network communication circuit configured to communicate with a rental system computer over a network,
a memory that stores a database containing access permission for the rental system, wherein the access permission for the rental location is based on an access code received from the rental system computer, and
a control circuit that is connected to the user interface, the memory and the network communication circuit, and controls the electronic lock,
wherein during a rental pickup of an item from the rental location, the user interface receives a rental access code from a customer who received it from the rental system computer, wherein the control circuit compares the rental access code with the access code in the database to determine the access permission, the control circuit releases the electronic lock for the rental location corresponding to the access permission, the rental system confirms the item is removed from the rental location and stores a rental timestamp in the memory, and sends pickup confirmation to the rental system computer with the rental timestamp; and
wherein during a rental return of the item from the rental location, the user interface receives the rental access code from the customer, the control circuit compares the rental access code with the access code in the database to determine the access permission, the control circuit releases the electronic lock for the rental location corresponding to the access permission, the rental system confirms the item is placed into the rental location and stores a return timestamp in the memory, and sends return confirmation to the rental system computer with the return timestamp.

14. The rental system of claim 13, further comprising a camera wherein during the return process, the camera captures an item image and the control circuit compares the item image with a pre-rental item image to confirm the item returned is the same as the item rented.

15. The rental system of claim 14, wherein the control circuit further evaluates a condition of the item returned as part of comparing the item image with the pre-rental item image.

16. The rental system of claim 13, wherein the rental system includes an RFID reader at the rental location and the item has an RFID tag, and the database contains an item identification including the RFID tag, wherein the RFID reader reads the RFID tag and the control circuit determines if the RFID tag matches the item identification.

17. The rental system of claim 16, wherein the RFID reader includes an antenna located in an access door to the rental location.

18. The rental system of claim 13, wherein, during the rental pickup of the item from the rental location, the control circuit further requires a customer verification for the access permission.

19. The rental system of claim 18, wherein the customer verification is a determination that the customer is present when the control circuit receives a geolocation from a mobile device associated with the customer.

20. The rental system of claim 13, wherein the electronic lock is wirelessly connected to the kiosk.
